(19) United States
(12) Patent Application Publication
(10) Pub. No.: US 2018/0150718 A1
(43) Pub. Date: May 31, 2018

(54) VISION-BASED NAVIGATION SYSTEM

(71) Applicant: GoPro, Inc., San Mateo, CA (US)

(72) Inventors: Sammy Omari, Zurich (CH); Pascal Gohl, Zurich (CH)

(21) Appl. No.: 15/364,990

(22) Filed: Nov. 30, 2016

(51) Int. Cl. G06K 9/46; G06K 9/00; G05D 1/00; B64D 47/08; B64C 39/02; G01C 21/00

(52) U.S. Cl. CPC G06K 9/4671; G06K 9/0063; G05D 1/0094; B64D 47/08; B64C 2201/146; G01C 21/00; G05D 1/0016; G05D 1/0044; B64C 39/024

(57) ABSTRACT

This disclosure describes systems and methods for vision-based navigation of an aerial vehicle. A method includes operations of acquiring a first image, and identifying features in a first image pyramid of the first image. The method includes acquiring a second image after the first image, and identifying the features in a second image pyramid of the second image. The method includes determining current navigation information of the aerial vehicle according to changes in position of the respective features between the first image pyramid and the second image pyramid. The method also includes predicting whether a sufficient number of the features will be identifiable at a third time that is in the future and after the second image was taken, and limiting flight as compared to the user flight instructions if an insufficient number of the features are predicted to be identifiable.

### TECHNICAL FIELD

This disclosure relates to Unmanned Aerial Vehicles (UAVs) and flight control systems therefor and, more particularly, a vision-based navigation system.

### BACKGROUND

UAVs may include one or more navigation systems that are used to determine navigation information of the UAV, such as the position, velocity, orientation, and orientation rate (e.g., angular velocity), which is used for controlling flight of the UAV. For example, the navigation information may be used to stabilize the UAV by maintaining the UAV in an intended position or moving along an intended flight path despite variable environmental conditions (e.g., wind). The one or more navigation systems may include a global positioning system (GPS) and/or a vision-based navigation system. The vision-based navigation system may be especially advantageous as a redundant navigation system to the GPS system or as a primary navigation system in environments where GPS signals are unreliable or unavailable (e.g., in an indoor environment). The vision-based navigation system relies on identifying and tracking sufficient numbers of visually distinct features between successive images. However, the successive images may decrease in the density of the visually distinct features (e.g., image texture) as the UAV moves over different landscapes (e.g., moving from over land to over water) and as the UAV changes altitudes (e.g., moving too high to cause features to blend together or too low toward a uniform surface). As a result of such movement and reduction of visually distinct features, the vision-based navigation system may become unreliable and/or inoperable.

### SUMMARY

This disclosure describes systems and methods for vision-based navigation of an aerial vehicle. A method includes operations of acquiring a first image at a first time, generating a first image pyramid that includes first pyramid layers that are copies of the first image at different resolutions, and identifying features in the first pyramid layers and generating a first position and a first size for the respective features. The method includes acquiring a second image at a second time that is after the first time, generating a second image pyramid that includes second pyramid layers of the second image at the different resolutions, identifying the features in the second pyramid layers and generating a second position and a second size for the respective features. The method includes determining current navigation information of the aerial vehicle according to changes from the first position to the second position of the respective features, which includes at least one of a current position, a current velocity, a current orientation, or a current orientation rate. The method also includes predicting a third position and a third size of the respective features in third pyramid layers of a third image pyramid corresponding to a third time. The third position and the third size of the respective features in the third pyramid layers are determined according to a dynamic model of the aerial vehicle, the current navigation information, and user flight instructions, and the third time is a future time that is after the second time. The method also includes determining according to the third position and the third size of the respective features whether a sufficient number of the features will be identifiable in the third pyramid layers for determining future navigation information of the aerial vehicle, and limiting flight of the aerial vehicle as compared to the user flight instructions upon predicting that an insufficient number of the features will be identifiable in the third image pyramid.

A method for navigating an aerial vehicle includes tracking visually distinctive features from first subsampled images of a first image taken at a first time to second subsampled images of a second image taken at a second time after the first time, determining navigation information for the second time based on the tracking; and predicting whether sufficient ones of the visually distinctive features will be identifiable at a future time to determine navigation information at the future time.

A method of vision-based navigation of an aerial vehicle includes predicting whether sufficient current features identified in current sub sampled images of a current image will be identifiable in future sub sampled image frames for determining future navigation information, and upon a determination that an insufficient number of the current features will be identifiable in the future subsampled image frames, generating modified flight instructions that are different from the user flight instructions. The operation of predicting is performed according to a dynamic model with inputs of current navigation information and user flight instructions.

### BRIEF DESCRIPTION OF THE DRAWINGS

The disclosed embodiments have other advantages and features that will be more readily apparent from the detailed description, the appended claims, and the accompanying figures. A brief introduction of the figures is below.

FIG. 1A shows an example of a UAV.

FIG. 1B shows an example of the imaging device associated with the UAV.

FIG. 1C shows an example of a remote controller and user interface for the UAV.

FIG. 2 is a block diagram illustrating components of a computing device.

FIG. 3 is a flowchart showing a vision-based navigation process.

FIG. 4 is a flowchart illustrating an operation of the vision-based navigation process of FIG. 3.

FIG. 5 is a flowchart illustrating further operations of the vision-based navigation process of FIG. 3.

### DETAILED DESCRIPTION

As discussed in further detail below, the present disclosure is directed to a vision-based navigation system and method (e.g., process) for a UAV, which predicts whether sufficient visually distinct features will remain identifiable over a desired flight path, and limits the UAV to a different flight path if insufficient visually distinct feature are predicted to be identifiable. More particularly, the vision-based navigation system and method utilize subsampled image copies of a current image, and predict future positions and sizes of visually distinct features identified in the subsampled image copies in order to determine whether those visually distinct features will remain identifiable in future subsampled image frames.

The present technology will now be described in detail with reference to the drawings that are provided as illustrative examples to enable those skilled in the art to practice the technology. The figures and examples below are not meant to limit the scope of the present disclosure to a single implementation or embodiment, but other implementations and embodiments are possible by way of interchange of or combination with some or all of the described or illustrated elements. Wherever convenient, the same reference numbers will be used throughout the drawings to refer to same or like parts.

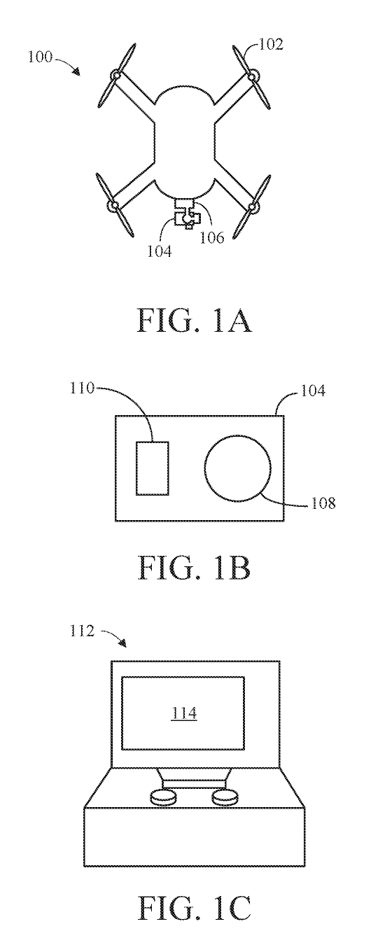

FIG. 1A shows an example of a UAV 100. In this embodiment, the UAV 100 has a quad-copter configuration, that is, the UAV 100 includes four rotors 102. Each rotor 102 is driven by a separate electric motor (not shown). However, the UAV 100 may be any form of an aerial vehicle. A battery pack (not shown) mounted on or in a body of the UAV 100 may supply electrical power to all four electric motors, flight electronics (not shown) associated with operation of UAV 100, and an imaging device 104 that provides still and video images by means of a communication link (not shown) to a ground-based user. The imaging device 104 may be coupled to a front of the UAV 100 using, for example, a movement mechanism 106.

In FIG. 1A, the movement mechanism 106 removably mounts the imaging device 104 to the UAV 100. The implementation of the movement mechanism 106 shown in this example is a three-axis gimbal that permits the imaging device 104 to be rotated about three independent axes. However, the movement mechanism 106 may include any type of translational and/or rotational elements that permit rotational and/or translational movement in one, two, or three dimensions of the imaging device 104 in respect to the UAV 100.

FIG. 1B shows an example of the imaging device 104 associated with the UAV 100. In FIG. 1B, the imaging device 104 is a GoPro Hero4® or Hero5® camera, however any type of imaging device 104 that can be coupled to the UAV 100, for example, through use of the movement mechanism 106, may be utilized. The imaging device 104 may include still image and video capture capabilities. FIG. 1B shows a lens 108 of the imaging device 104 and a display screen 110 associated with the imaging device 104. Means for coupling the imaging device 104 to the UAV 100 and/or the movement mechanism 106 are not shown.

FIG. 1C shows an example of a remote controller 112 including a user interface 114 for operating the UAV 100. The remote controller 112 may include a communications interface (not shown) via which the remote controller 112 may receive and send commands related to operation of the UAV 100, the imaging device 104, and the movement mechanism 106. The commands can include movement commands, configuration commands, operational control commands, and imaging commands. In some implementations, the remote controller 112 may be a smartphone, a tablet computer, a phablet, a smart watch, a portable computer, and/or another device configured to receive user input and communicate information with the imaging device 104, the movement mechanism 106, and/or the UAV 100.

For example, flight direction, attitude, and altitude of the UAV 100 may all be controlled by controlling speeds of the motors that drive the respective rotors 102 of the UAV 100. During flight, a GPS receiver on the UAV 100 may provide navigational data to the remote controller 112 for use in determining flight paths and displaying current location through the user interface 114. A vision-based navigation system may also be implemented that tracks visually significant features through image data captured by the imaging device 104 to provide the necessary speed and position of the UAV 100 to the remote controller 112. The vision-based navigation system (e.g., stabilization system) may, for example, be used to control movement of the UAV 100 in a predictable manner, such as preventing unintended movement of the UAV 100 (e.g., lateral drifting and/or tilting).

The communications interface may utilize any wireless interface configuration, e.g., WiFi, Bluetooth (BT), cellular data link, ZigBee, near field communications (NFC) link, e.g., using ISO/IEC 14443 protocol, ANT+ link, and/or other wireless communications link. In some implementations, the communications interface may be effectuated using a wired interface, e.g., HDMI, USB, digital video interface, display port interface (e.g., digital display interface developed by the Video Electronics Standards Association (VESA), Ethernet, Thunderbolt), and/or other interface.

The remote controller 112 may operate a software application (e.g., GoPro Studio®, GoPro App®, and/or other application) configured to perform a variety of operations related to camera configuration, positioning of the movement mechanism 106, control of video acquisition, and/or display of video captured by the imaging device 104 through the user interface 114. An application (e.g., GoPro App)® may enable a user to create short video clips and share video clips to a cloud service (e.g., Instagram®, Facebook®, YouTube®, Dropbox®); perform full remote control of functions of the imaging device 104; live preview video being captured for shot framing; mark key moments while recording (e.g., HiLight Tag®, View HiLight Tags in GoPro Camera Roll®) for location and/or playback of video highlights; wirelessly control camera software; and/or perform other functions. Various methodologies may be utilized for configuring the imaging device 104 and/or displaying the captured information.

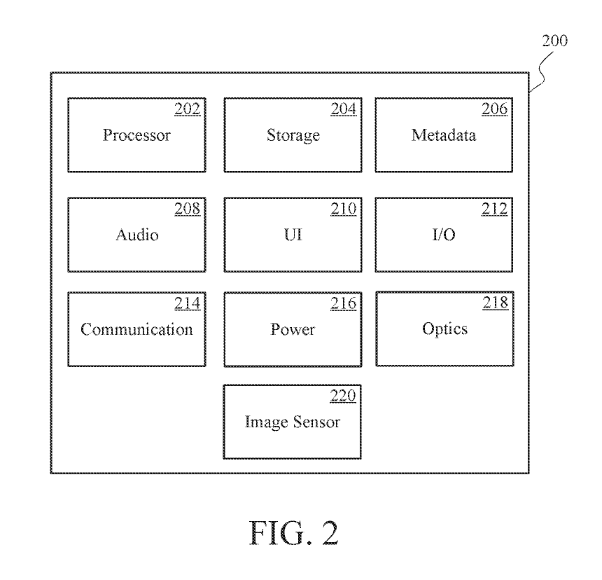

FIG. 2 is a block diagram illustrating components of a computing device 200. The computing device 200 may be a single component of the UAV 100, the imaging device 104, the movement mechanism 106, or the remote controller 112. The computing device 200 may be multiple computing devices distributed in various ways between the UAV 100, the imaging device 104, the movement mechanism 106, or the remote controller 112. In the examples described, the computing device 200 may provide communication and control functions to the various components described in reference to FIGS. 1A, 1B, and 1C.

The computing device 200 may include a processor 202. The processor 202 may include a system on a chip (SOC), microcontroller, microprocessor, CPU, DSP, ASIC, GPU, or other processors that control the operation and functionality of the UAV 100, the imaging device 104, the movement mechanism 106, and/or the remote controller 112. The processor 202 may interface with mechanical, electrical, sensory, and power modules via driver interfaces and software abstraction layers. Additional processing and memory capacity may be used to support these processes. These components may be fully controlled by the processor 202. In some implementations, one or more components may be operable by one or more other control processes (e.g., a GPS receiver may include a processing apparatus configured to provide position and motion information to the processor 202 in accordance with a given schedule (e.g., values of latitude, longitude, and elevation at 10 Hz.))

The computing device 200 may also include electronic storage 204 in which configuration parameters, image data, and/or code for functional algorithms may be stored. The electronic storage 204 may include a system memory module that is configured to store executable computer instructions that, when executed by the processor 202, control various functions of the UAV 100, the imaging device 104, the movement mechanism 106, and/or the remote controller 112. The electronic storage 204 may also include storage memory configured to store content (e.g., metadata, frames, video, and audio) captured by the imaging device 104 or sensors associated with the UAV 100, the movement mechanism 106, and/or the remote controller 112.

The electronic storage 204 may include non-transitory memory configured to store configuration information and processing code configured to enable video information and metadata capture. The configuration information may include capture type (video, frames), image resolution, frame rate, burst setting, white balance, recording configuration (e.g., loop mode), audio track configuration, and other parameters that may be associated with audio, video, and metadata capture. Additional electronic storage 204 may be available for other hardware, firmware, or software needs of the UAV 100, the imaging device 104, the movement mechanism 106, and/or the remote controller 112. The memory and processing capacity may aid in management of processing configuration (e.g., loading, replacement) operations during a startup and/or other operations.

The computing device 200 may also include optics 218, which may include the lens 108 (see FIG. 1B) as an optical element of the imaging device 104. In some implementations, the lens 108 may be a fisheye lens that produces images having a fisheye or near-fisheye field of view (FOV). Other types of optics 218 may also be utilized such as a standard lens, macro lens, zoom lens, special-purpose lens, telephoto lens, prime lens, achromatic lens, apochromatic lens, process lens, wide-angle lens, ultra-wide-angle lens, infrared lens, ultraviolet lens, perspective control lens, other lens, and other optical element. In some implementations, the optics 218 may implement focus controller functionality configured to control the operation and configuration of the camera lens. The optics 218 may receive light from an object and transmit received light to an image sensor 220.

The imaging device 104 may include one or more image sensors 220 such as a charge-coupled device (CCD) sensor, active pixel sensor (APS), complementary metal-oxide semiconductor (CMOS) sensor, N-type metal-oxide-semiconductor (NMOS) sensor, and other image sensor. The image sensor 220 may be configured to capture light waves gathered by the optics 218 and generate image data based on control signals from a sensor controller 222. The image sensor 220 may be configured to generate a first output signal conveying first visual information regarding an object. The visual information may include one or more of an image, a video, and other visual information. The optics 218 and the image sensor 220 may be contained within a housing, which may offer impact protection to the module and the sensor.

The computing device 200 may include or be in communication with metadata sources 206. The metadata sources 206 may include sensors associated with the UAV 100, the imaging device 104, and/or the movement mechanism 106. The sensors may include an inertial measurement unit (IMU), an accelerometer, a gyroscope, a barometer, a magnetometer, a compass, a LIDAR sensor, a global positioning satellite (GPS) receiver, an altimeter, an ambient light sensor, a temperature sensor, a pressure sensor, a heart rate sensor, a depth sensor (such as radar, an infra-red-based depth sensor, such as a Kinect-style depth sensor, and a stereo depth sensor), and/or other sensors. The imaging device 104 may also provide metadata sources 206, e.g., image sensors, a battery monitor, storage parameters, and other information related to camera operation and capture of content. The metadata sources 206 may obtain information related to an environment of the UAV 100 and aspects in which the content is captured.

By way of a non-limiting example, an accelerometer may provide motion information including acceleration vectors from which velocity vectors may be derived, and a barometer may provide pressure information from which elevation may be derived. A gyroscope may provide orientation information, a GPS sensor may provide GPS coordinates and time for identifying location, and an altimeter may obtain altitude information. The metadata sources 206 may be rigidly coupled to the UAV 100, the imaging device 104, the movement mechanism 106, and/or the remote controller 112 such that the processor 202 may be operable to synchronize various types of information received from various types of metadata sources 206.

For example, using timing information, metadata information may be related to content (frame or video) captured by an image sensor. In some implementations, the metadata capture may be decoupled from the video or frame capture. That is, metadata may be stored before, after, and in-between one or more video clips or frames. In one or more implementations, the processor 202 may perform operations on the received metadata to generate additional metadata information. For example, the processor 202 may integrate received acceleration information to determine a velocity profile of the imaging device 104 during a recording of a video.

The computing device 200 may include or be in communication with audio sources 208, such as one or more microphones, configured to provide audio information that may be associated with images acquired by the imaging device 104 or commands provided by the remote controller 112. Two or more microphones may be combined to form a microphone system that is directional. Such a directional microphone system can be used to determine the location of a sound source and to eliminate undesirable noise originating in a particular direction. Various audio filters may be applied as well. In some implementations, audio information may be encoded using AAC, AC3, MP3, linear PCM, MPEG-H, and other audio coding formats (audio codec.) In one or more implementations of spherical video and audio, the audio codec may include a 3-dimensional audio codec. For example, an Ambisonics codec can produce full surround audio including a height dimension. Using a G-format Ambionics codec, a special decoder may not be required.

The computing device 200 may include or be in communication with a user interface (UI) 210. The UI 210 may include a display configured to provide information related to operation modes (e.g., camera modes, flight modes), connection status (e.g., connected, wireless, wired), power modes (e.g., standby, sensor, video), metadata sources 206 (e.g., heart rate, GPS, barometric), and/or other information associated with the UAV 100, the imaging device 104, the movement mechanism 106, and/or the remote controller 112. In some implementations, the UI 210 may include virtually any device capable of registering inputs from and communicating outputs to a user. These may include, without limitation, display, touch, gesture, proximity, light, sound receiving/emitting, wired/wireless, and/or other input/output devices. The UI 210 may include a display, one or more tactile elements (e.g., joysticks, switches, buttons, and/or virtual touch screen buttons), lights (LED), speaker, and/or other interface elements.

The UI 210 may be configured to enable the user to provide commands to the UAV 100, the imaging device 104, and/or the movement mechanism 106. For example, the user interface 114 shown in FIG. 1C is one example of the UI 210. User commands provided using the UI 210 may be encoded using a variety of approaches, including but not limited to duration of a button press (pulse width modulation), number of button presses (pulse code modulation), or a combination thereof. For example, two short button presses through the UI 210 may initiate a sensor acquisition mode. In another example, a single short button press may be used to communicate (i) initiation of video or frame capture and cessation of video or frame capture (toggle mode) or (ii) video or frame capture for a given time duration or number of frames (burst capture). Other user command or communication implementations may also be realized, such as one or more short or long button presses or toggles of a joystick.

The computing device 200 may include an input/output (I/O) module 212. The I/O module 212 may be configured to synchronize the imaging device 104 with the remote controller 112, a second capture device, a smartphone, and/or a video server. The I/O module 212 may be configured to communicate information to and from various I/O components. The I/O module 212 may include a wired or wireless communications interface (e.g., Wi-Fi, Bluetooth, USB, HDMI, Wireless USB, Near Field Communication (NFC), Ethernet, a radio frequency transceiver, and other interfaces) configured to communicate to one or more external devices. The I/O module 212 may interface with LED lights, a display, a button, a microphone, speakers, and other I/O components. In one or more implementations, the I/O module 212 may be coupled to an energy source such as a battery or other DC electrical source.

The computing device 200 may include a communication module 214 coupled to the I/O module 212. The communication module 214 may include a component (e.g., a dongle) having an infrared sensor, a radio frequency transceiver and antenna, an ultrasonic transducer, and/or other communications interfaces used to send and receive wireless communication signals. In some implementations, the communication module 214 may include a local (e.g., Bluetooth, Wi-Fi) or broad range (e.g., cellular LTE) communications interface configured to enable communications between the UAV 100, the imaging device 104, the movement mechanism 106, and/or the remote controller 112.

The communication module 214 may employ communication technologies including one or more of Ethernet, 802.11, worldwide interoperability for microwave access (WiMAX), 3G, Long Term Evolution (LTE), digital subscriber line (DSL), asynchronous transfer mode (ATM), InfiniBand, PCI Express Advanced Switching, and/or other communication technologies. By way of non-limiting example, the communication module 214 may employ networking protocols including one or more of multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and/or other networking protocols.

Information exchanged over the communication module 214 may be represented using formats including one or more of hypertext markup language (HTML), extensible markup language (XML), and/or other formats. One or more exchanges of information between the imaging device 104 and outside devices, such as the remote controller 112, may be encrypted using encryption technologies including one or more of secure sockets layer (SSL), transport layer security (TLS), virtual private networks (VPNs), Internet Protocol security (IPsec), and/or other encryption technologies.

The computing device 200 may include a power system 216 that may moderate a power supply based on the needs of the UAV 100, the imaging device 104, the movement mechanism 106, and/or the remote controller 112. For example, a battery, solar cell, inductive (contactless) power source, rectification, or other power supply housed within the UAV 100 may be controlled by the power system 216 to supply power for the imaging device 104 and/or the movement mechanism 106 when in a coupled state as shown in FIG. 1A

The UAV 100 employs a vision-based navigation system and a vision-based navigation method (e.g., process) performed thereby, which analyze images to determine navigation information of the UAV 100. The navigation information may include current information of the UAV 100, such as position, velocity (e.g., translational velocity), orientation, and orientation rate (e.g., angular velocity). The vision-based navigation system may be used to stabilize the UAV 100, for example, by tracking the position of the UAV 100 and operating the rotors 102 to prevent deviations in movement from a desired flight path or position of the UAV 100. Use of the vision-based navigation system may be advantageous, for example, when a GPS system of the UAV 100 is inoperable or unreliable (e.g., in an indoor environment), or the UAV 100 does not include a GPS system. The vision-based navigation system and the method are additionally configured to limit (e.g., confine, bound, redirect, and/or restrict) travel or flight of the UAV 100 to physical regions (e.g., a flight envelope) in which the vision-based navigation system is able to reliably operate. In the discussion that follows, the vision-based navigation system and the vision-based navigation method employed thereby may generally be referred to more simply as the system or the method (e.g., process), respectively.

The system and the method determine the navigation information of the UAV by tracking features in successive images. By determining the changes in the positions of various features in a first image (e.g., previous or preceding image) taken at a first time (e.g., previous or preceding time) to the same features in a second image (e.g., current image) at a second time (e.g., current time), the system and the method are able to determine (e.g., estimate) the position, velocity, orientation, and orientation rate of the UAV 100 at the current time. However, if insufficient features are present in later images, the system is unable to determine the navigation information at later times.

For example, when the UAV 100 is approaching a texture-less (e.g., feature devoid) surface from a texture-rich (e.g., feature dense) surface, a sufficient part of the image (e.g., video frame) must have a texture-rich surface in sight to ensure continued operation of the vision-based navigation system. As an example, if the UAV were traveling horizontally over a texture-rich forest and transitioned to traveling over a lake, the lake would be relatively texture-less and may not include sufficient visually distinctive features to support continued operation of the vision-based navigation system. Similarly, as the UAV 100 increases in altitude, small features may become indistinguishable and no longer support continued operation of the vision-based navigation system.

The vision-based navigation system disclosed herein and the method employed thereby limit movement (e.g., flight) of the UAV 100 to those physical regions in which the system can identify features (e.g., visually distinctive features) in sufficient quantities for deriving sufficient navigation information for safely, reliably, and/or predictably stabilizing or otherwise navigating the UAV 100. More particularly, the system and the method predict whether sufficient features will be identifiable at a future time for the system to reliably operate, and may limit intended movement (e.g., a flight path) of the UAV 100 accordingly. Movement (e.g., flight) is limited in directions parallel with a plane of the images (e.g., horizontal) if the system and the method predict that insufficient previously-identified features will remain within a field of view of the imaging device 104 at the future time (i.e., at a future position and orientation of the UAV 100). Movement (e.g., flight) may also be limited in a direction perpendicular with the plane of the images (e.g., vertical) if a sufficient number of the features that are predicted to remain in the field of view are not also predicted to remain identifiable (i.e., visually distinguishable). To predict whether such features will remain identifiable, the system and the method generate subsampled copies of the current image (e.g., an image pyramid) to track features of different sizes that are identifiable in some of the subsampled copies the image but not others.

The vision-based navigation system generally includes the imaging device 104 and the computing device 200, which cooperatively perform the vision-based navigation method. The vision-based navigation system may additionally include, receive inputs from, and/or provide outputs to other components or systems, such as the rotors 102, the movement mechanism 106, the remote controller 112, the metadata sources 206, or other components described previously. Components of the vision-based navigation system are preferably located onboard the UAV 100, but may include components and/or perform functions at other locations.

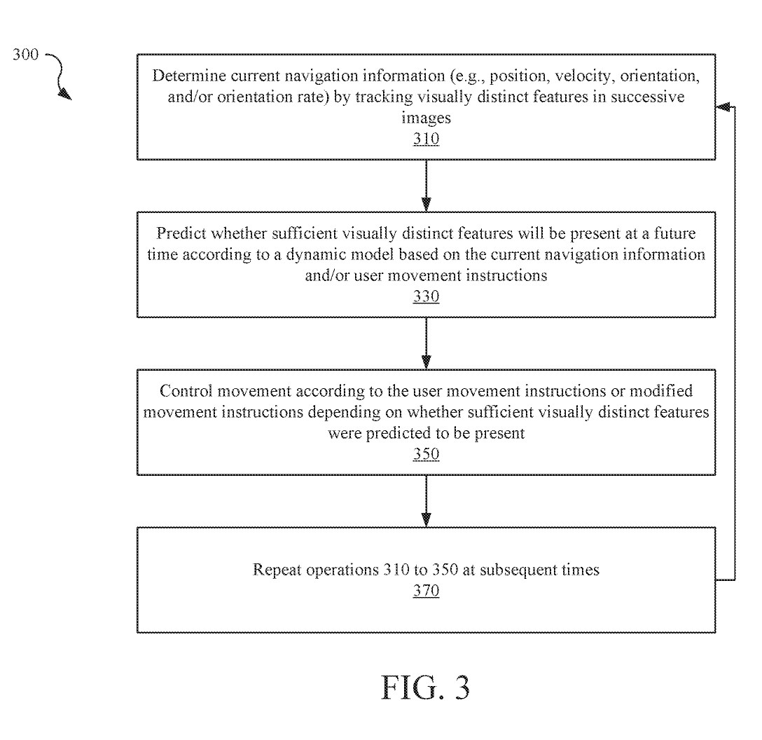

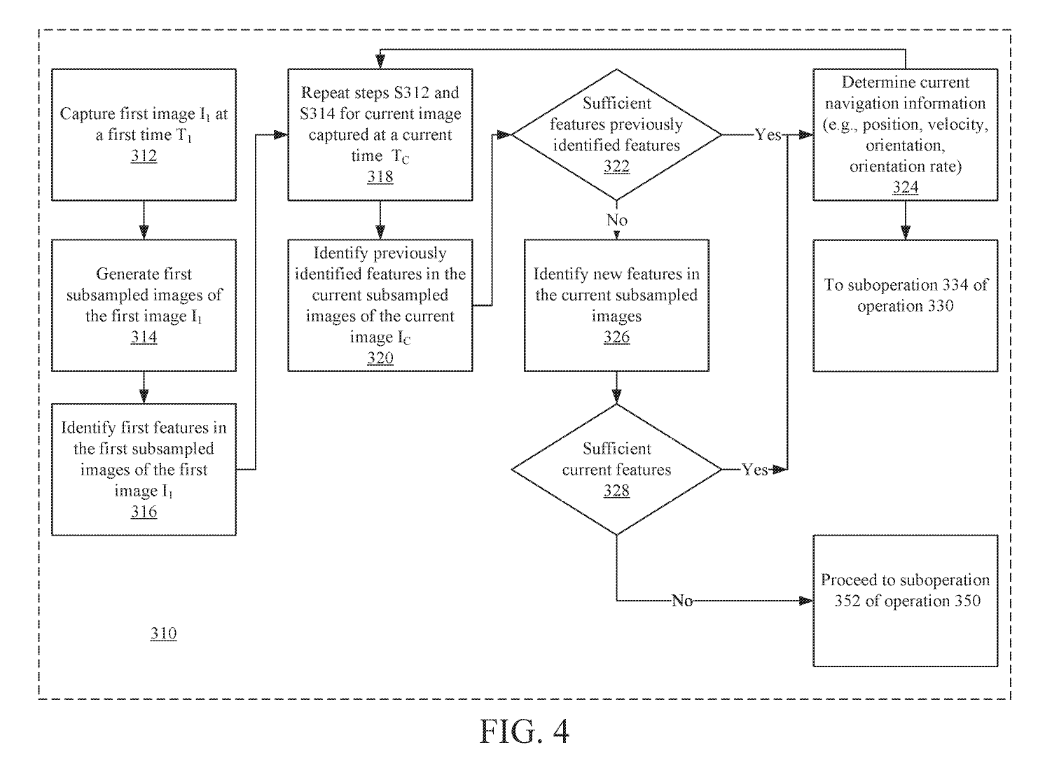

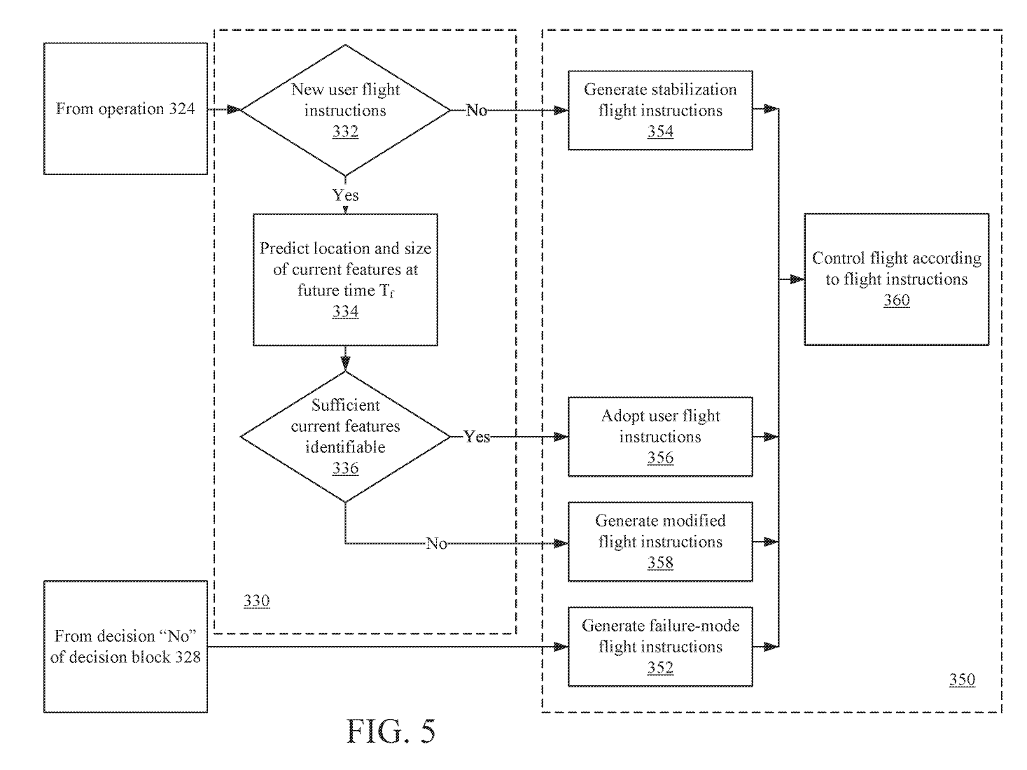

FIG. 3 is a flowchart illustrating an embodiment of the vision-based navigation method or process 300 employed by the vision-based navigation system. The process 300 includes a first operation 310 of determining current navigation information (e.g., current position, current velocity, current orientation, and/or current orientation rate) by tracking visually distinct features in successive images, an operation 330 of predicting whether sufficient visually distinct features will be identifiable at a future time, and an operation 350 of controlling movement according to user movement instructions or modified movement instructions depending on whether sufficient visually distinct features are predicted to be present at the future time. Operations 310 through 350 are then repeated at subsequent times in another operation 370. Operations 310 through 370 are discussed in further detail below with reference to FIGS. 4 and 5.

FIG. 4 is a flowchart illustrating the first operation 310 of determining the current navigation information. As referenced above, the current navigation information is determined by tracking visually distinct features in successive images (e.g., in an image or video stream). By determining changes in the positions of common features (e.g., the changes in pixel locations of the features) between successive images, changes in position, velocity, orientation, and/or orientation rate of the UAV 100 can be determined.

More particularly, the operation 310 identifies and tracks visually distinct features between subsampled image copies of images taken in succession, which supports visual-based navigation as the UAV 100 moves to different altitudes. In a given set of the subsampled images, different features may be identifiable in some (e.g., one) but not others (e.g., none) of the subsampled images. Smaller features may be identifiable in one or more of the subsampled images with higher resolutions but are not identifiable in those subsampled images with lower resolutions. Conversely, larger features may be identifiable in one or more of the subsampled images with the lower resolution but are not identifiable in those subsampled images with a higher resolution. Thus, as the UAV 100 changes altitude and features change in size, features identified in the previous subsampled images at certain resolutions may be identifiable in later subsampled images at different resolutions. For example, if decreasing altitude, those previously small features may become large features and identifiable in lower resolution images. If increasing in altitude, those previously large features may become small features and identifiable in higher resolution images. By identifying different features in different subsampled copies of the same image (e.g., smaller features at higher resolutions, and larger features at lower resolutions), the system is thereby able to track those features across different resolutions of the subsampled images despite some features ceasing to be being identifiable at their previous resolution as the UAV 100 moves.

In an initial suboperation 312 of the operation 300, a first image I₁ (e.g., initial, preceding, or previous image) is captured by the imaging device 104 at a first time T₁ (e.g., initial, preceding, or previous time). The first image I₁, or data representing the first image I₁, is transferred to and stored by the computing device 200. The first image I₁ may, for example, be a frame of a video stream of the imaging device 104.

The operation 310 then proceeds to a suboperation 314 in which a series of subsampled image copies of the first image I₁ are generated at different resolutions by the computing device 200. The series of subsampled image copies may be referred to as subsampled images, a set of subsampled images, or an image pyramid, while the individual subsampled image copies may be referred to as a subsampled image, or a pyramid layer. Each of the subsampled images is a copy of the first image at subsampled (i.e., reducing) resolutions, such as full resolution, ½ resolution (i.e., ¼ the pixels of the full resolution), ¼ resolution (i.e., 1/16 of the pixels of the full resolution), ⅛ resolution (i.e., 1/64 of the pixels of the full resolution), and/or 1/16 resolution (i.e., 1/256 of the pixels of the full resolution). The image pyramid may include image copies at a different number of resolutions (e.g., more or fewer than five different resolutions) and/or at different resolution values.

The operation 310 then proceeds to the suboperation 316 in which the subsampled images of the first image I₁ are analyzed. More particularly, the subsampled images are analyzed to identify visually distinct features (e.g., first features, first group of features), which may be tracked in subsequent images in later suboperations (discussed further below). A position (e.g., pixel location) and description (e.g., size, pixel size, image patch, and/or identifying information) are generated for each of the features identified in each of the subsampled images. Suitable image processing and/or optical recognition software may be employed by the system and the method for identifying the features, as well as generating the position and the description therefor.

After the first image is captured and the first subsampled images are generated and analyzed, the operation 310 then tracks the first visual features from the first subsampled images (i.e., the previous image pyramid) to one or more images captured at subsequent times to determine the navigation information of the UAV 100. More particularly, the operation 310 moves from the suboperation 316 to a suboperation 318 in which the suboperations 312 and 314 are repeated at a current time T_{C} (e.g., a second or subsequent time). Thus, a current image I_{C} is captured, and current subsampled images (e.g., current pyramid layers, current image pyramid) are generated for the current image I_{C}. The current image I_{C} may, for example, be an image captured by the imaging device 104 immediately subsequent to the first image I₁ (e.g., the next frame in an image stream) or an image captured at another time after the first/previous time (e.g., every number of image frames, or a predetermined time interval).

The operation 310 then moves to a suboperation 320 in which the current subsampled images are analyzed to identify the first features therein (i.e., previously identified or common features with the first subsampled images). The system, for example, identifies those features in the current subsampled images that have the same or similar image patch (e.g., description) as the features identified in the first subsampled images. The first features may be identified in the current subsampled images having different resolutions than the first subsampled images in which the first features were previously identified.

Motion data from (e.g., measured by) the metadata sources 206 (e.g., IMU sensors, such as MEMS based accelerometers and gyroscopes) may be used to locate the first features in the current subsampled images, for example, by estimating regions and/or resolutions of the current subsampled images in which the features may be expected to be found. It should be noted, however, that the accuracy of such MEMS devices may not be sufficient on their own to reliably determine the position, velocity, orientation, and orientation rate over an extended duration (e.g., more than a few seconds) due to bias and/or noise of such MEMS devices.

The operation 310 then moves to a decision block 322 in which the system determines whether a sufficient number of the first features were again identified in the current subsampled images. That is, it is determined whether a sufficient number of the features have been identified in and can be tracked between the first subsampled images and the current subsampled images for determining the current navigation information. By assessing whether a sufficient number of the first features remain in the current subsampled images, the system may rely on the same features for as long as possible, for example, to avoid drift in determining navigation information in subsequent operations (discussed in further detail below) and/or to avoid identifying and/or tracking too many features (e.g., that might otherwise unnecessarily consume processing power, as compared to that necessary for acceptably and/or reliably determining navigation information).

If it is determined (e.g., a determination is made) in the decision block 322 that a sufficient number of the first features were identified in the current subsampled images, the operation 310 then proceeds to a suboperation 324 in which the current navigation information is determined (as discussed in further detail below) based on the first features.

If it is determined in the decision block 322 that an insufficient number of the first features were identified in the current subsampled images, the operation 310 proceeds to a suboperation 326 in which new features (e.g., second, additional, newly identified, or uncommon features) are identified in the current subsampled images and for which are generated a position and description.

The operation 310 then moves to a decision block 328, which determines whether a sufficient number of the first and the new features were identified in the current image I_{C} (e.g., in the current subsampled images or image pyramid). Those features identified in the current subsampled images, whether the previously identified features or the new features, are referred to hereafter as the current features.

If it is determined in the decision block 328 that sufficient current features were identified in the current subsampled images, the operation 310 then proceeds to the suboperation 324 (discussed below) in which the current navigation information is determined.

If it is determined in the decision block 328 that insufficient current features were identified in the current subsampled images, the vision-based navigation system fails and/or is rendered inoperable. The operation 310 then proceeds to a suboperation 352 of the operation 350 in which failure-mode flight instructions are determined. Broadly speaking, the operation 350 includes various suboperations (e.g., 352, 354, 356, 358) in which flight instructions (e.g., trajectory commands) are generated (e.g., by a trajectory controller) in response to various decision blocks. A further suboperation 360 controls flight of the UAV 100 according to the appropriate flight instructions (e.g., by generating rotor commands or otherwise controlling operation of the rotors 102). The failure-mode flight instructions determined in the suboperation 352 may, for example, include immediate descent and landing of the UAV 100, or backtracking along the previous flight path (e.g., based on IMU data).

In the suboperation 324, the system determines current navigation information of the UAV 100. That is, the position, velocity, orientation, orientation rate, any components thereof (e.g., translational velocity), and/or any combinations thereof of the UAV 100 are determined. For example, among other combinations, the position, velocity, orientation, and orientation rate may be determined; the position and orientation may be determined; the changes in or relative position and orientation may be determined; the velocity and orientation rate may be determined; and/or the translational velocity may be determined. More particularly, the current navigation is determined based on changes in the positions of common features (i.e., the first features) between the first image I₁ (i.e., the first subsampled images or first pyramid layers) and the current image I_{C} (i.e., the current subsampled images or current pyramid layers), as well as the time difference between the first time T₁ and the current time T_{C}.

Changes in the position and the orientation of the UAV 100 are determined based on changes in the positions (e.g., point correspondences) of the current features between the first subsampled images and the current subsampled images. For example, changes in the pixel location of the features between the first subsampled images and the current subsampled images correspond to an opposite direction of movement of the UAV 100 (e.g., a feature that has moved left in the images corresponds to the UAV 100 having moved right in real space). Rates of change in the position (e.g., velocity) and orientation (e.g., orientation rate) of the UAV 100 may be determined based on the changes in the position and the orientation and the time difference between current time T_{C} and the first time T₁. The scale of the changed position and orientation of the UAV 100 in real space may, for example, be based on the previously determined distance (e.g., height) of the UAV 100 from the feature, or based on another input (e.g., altitude or distance determined by one of the metadata sources 206, such as an altimeter or other distance or height measuring device).

The current position and orientation of the UAV 100 are then determined, for example, by a motion estimator or model. Inputs to the motion estimator include vision-based inputs (i.e., from tracking features between successive images pyramids, such as changes in or measurements of the relative position and orientation of the UAV 100, or velocity and/or orientation rate of the UAV 100) and may also include other available information from one or more of the metadata sources 206 (e.g., IMU, such as MEMS-based accelerometers and/or gyroscopes, altimeter, and/or GPS). The motion estimator may, for example, be a Kalman filter or other probabilistic model, which combines, filters, and/or weights the various inputs, while accounting for noise and/or uncertainty associated with each of the information sources (e.g., vision-based, IMU, altimeter, and/or GPS). Weighting of the various inputs may be dynamic based on expected noise and/or uncertainty of the information source. For example, vision-based navigation information (e.g., data related to translational movement) may weighted higher when the UAV 100 is at lower altitudes and the vision-based navigation information is expected to be more accurate and lower when the UAV 100 is at higher altitudes.

After the current navigation information is determined in the suboperation 324, the process 300 moves to operation 330 in which the system predicts whether sufficient visually distinct features will be identifiable (discussed in further detail below).

After suboperation 324, the operation 310 also repeats suboperations 318 to 328 at successive times (e.g., the next frame or another predetermined interval, as referenced above). What were previously the current image, the current subsampled images, and the current features, become a previous image, previous subsampled images, and previously-identified features. A now current image is captured at the now current time (i.e. suboperation 312), now current subsampled images are generated from the now current image (i.e. suboperation 314), the previously identified features are identified in the now current subsampled images (i.e. suboperation 320), new features are identified are identified in the now current subsampled images (i.e., suboperation 326 based on decision block 322), and the now current navigation information is determined from changes in positions of the previously identified features in the current subsampled images (i.e., suboperation 324). Suboperations 318 to 328 may be repeated as part of operation the 370, or may be repeated at a greater rate than at which the operations 330 and 350, or suboperations thereof, are performed.

While operation 310 has been discussed as tracking the features between two successive images, the features may be tracked across more than two successive images (e.g., three, four, five), although within a short time window (e.g., one second). Furthermore, while the various suboperations have been discussed as generally occurring serially, it should be understood that various ones of the suboperations may occur simultaneously (e.g., subsampled images may be generated for one image, while a subsequent image is captured).

FIG. 5 is a flow chart illustrating the operations 330 and 350. In the operation 330, the system predicts whether sufficient visually distinct features will be identifiable at a future time T_{f} (e.g., a third time after the current time). The system predicts future positions and future sizes for the current features in predicted subsampled image frames (e.g., predicted or third pyramid layers). Prediction of the future positions and the future sizes of the current features is determined according to a dynamic model (e.g., movement or flight model) of the UAV 100 based on inputs of the current navigation information and user movement instructions (e.g., user flight instructions). The future time T_{f} may be the next time at which an image would be captured by the imaging device 104 (e.g., the next frame of a video stream), or may be at another time, such as a predetermined interval (e.g., one second) or a dynamic interval (e.g., based on velocity of the UAV 100 and/or distance of the UAV 100 from an imaged surface, such as the altitude of the UAV 100).

In a decision block 332 of the operation 330, it is determined if new user flight instructions have been received. The user flight instructions may, for example, be input by the user via the remote controller 112. For example, the user may input the flight instructions via the user interface 114. The flight instructions may be instructions for movement of the UAV 100 in one or more of six degrees of freedom (e.g., translational motion forward/backward, rightward/leftward, and upward/downward, and rotational movement about roll, pitch, and yaw axes) at desired translational and/or rotational velocities.

If new user flight instructions have not been received, the process 300 proceeds to suboperation 354 of the operation 350 in which stabilization flight instructions are generated based on the current navigation information, for example, to maintain the position of the UAV 100. In the suboperation 360, flight of the UAV 100 is then controlled according to the stabilization flight instructions.

If new user flight instructions have been received, the operation 330 then moves to a suboperation 334 in which the system predicts (e.g., determines, estimates) the future locations and the future sizes of the current features in predicted subsampled image frames (e.g., third, future, or predicted pyramid layers, subsampled images, or reference frames of a third, future, or predicted image pyramid). The predicted subsampled image frames are reference frames (e.g., a field of view of the imaging device 104 if a future image were to be taken) that are representative of future subsampled images that would be generated if a future image (e.g., third image, or predicted image) were taken by the imaging device 104 (e.g., at the future time T_{f} from a future position and future orientation of the UAV 100). The predicted subsampled image frames need not be fully generated images.

The future locations and the future sizes of the features within the predicted subsampled image frames are determined according to the dynamic model based on inputs of the current navigation information and the user flight instructions. The dynamic model may account for dynamic characteristics of the UAV 100, including the ability of the rotors 102 to individually and/or collectively accelerate the UAV 100 in the six degrees of freedom given the current velocity and orientation rate (and thereby the momentum) of the UAV 100 and the current output (e.g., speed) of the rotors 102. In the suboperation 334, the system may additionally use as input motion data from the metadata sources 206 (e.g., IMU sensors, such as MEMS based accelerometers and gyroscopes).

Based on the dynamic model and the various inputs (e.g., current navigation information, user instructions, and/or motion data), the system may compute the future positions and the future sizes of the current features within the predicted subsample frames in any suitable manner. For example, the system may compute vector predictions (e.g., predicted correspondences) for each of the current features and/or may predict a future location and a future orientation of the UAV 100 from which the future positions and the future sizes of the current features are derived.

With individually computed vector predictions, in-plane components of the vector predictions (e.g., in the x- and y-dimensions in plane with the field of view of the subsampled images, such as the horizontal components) are used to determine the predicted locations of the current features in the predicted subsampled image frames. Accordingly, various ones of the current features may be predicted to be outside of the subsampled image frames (e.g., if they would not be within the field of view of the imaging device 104 at the future time T_{f}). The perpendicular component of the vectors (e.g., in the z-dimension, such the vertical component) is used to determine the size of the current features in the predicted subsampled image frames. The predicted size of the current features may be used to predict which of the subsampled images (i.e., resolutions) the current features would be identifiable in. Various ones of the current features may be predicted to be too small or too large to be identifiable in various ones (e.g., all) of the predicted subsampled image frames.

The operation 330 moves from suboperation 334 to a decision block 336 in which the system determines whether sufficient ones of the current features would be identifiable (e.g., located within and of appropriate size to be identifiable) in the predicted subsampled image frames to support operation of the vision-based navigation system. That is, the system determines whether sufficient ones of the current features will remain available (e.g., both in the image frame, and neither too small nor too large to be identifiable in the highest and the lower resolution subsampled image frames, respectively) to determine navigation information at the future time T_{f}, (e.g., future navigation information).

If it is determined in the decision block 336 that sufficient features were predicted to be identifiable in the predicted subsampled image frames, the process 300 proceeds to a suboperation 356 of the operation 350 to adopt (i.e., use) the user flight controls. In the suboperation 360, the flight of the UAV 100 is then controlled according to the user flight instructions. That is, the rotors 102 are controlled (e.g., operated) in manner to move the UAV 100 as instructed by the user.

If it is determined in the decision block 336 that sufficient features were not predicted to be present at the future subsampled image frames, the process 300 proceeds to a suboperation 358 in which the system generates modified flight instructions, and flight of the UAV 100 is then controlled according to the modified flight instructions in a suboperation 360.

In the suboperation 358, the modified flight instructions may be determined in various manners. Generally speaking, the modified flight instructions are configured to limit travel of the UAV 100 to physical regions in which the features are predicted to be identifiable in sufficient numbers for operation of the vision-based navigation system. For example, the modified flight instructions, as compared to the user instructions, may include a modified translational velocity (e.g., reduced speed and/or changed direction) and/or a modified angular velocity (e.g., reduced speed of rotation and/or changed axis of rotation).

In one example, the modified flight instructions may restrict movement of the UAV 100 in a manner that ensures the UAV 100 does not move to (i.e., can stop prior to being in) positions where sufficient ones of the current features are no longer predicted to be identifiable (e.g., trackable) by the system (e.g., such features being outside the field of view of the imaging device 104 and/or being insufficiently distinctive in any of the predicted subsampled image frames). For example, the modified flight instructions may limit the velocity of the UAV 100 based on a time horizon at which the current features are predicted to not be identifiable and a maximum deceleration of the UAV 100 (e.g., based on the dynamic model). The velocity may be limited by a greater degree at lower altitudes at which the imaging device 104 has a relatively limited field of view in real space as compared to higher altitudes at which the imaging device 104 has a relatively larger field of view. As such, the modified flight instructions (e.g., limited velocity) may be derived from a ratio of velocity to altitude.

In another example, the modified flight instructions include a safety margin, which ensures that greater than a sufficient number of the current features are predicted to be identifiable in the predicted subsampled image frames. For example, the safety margin may require that more the current features be predicted to be identifiable in greater numbers than are required to determine the navigation information at the future time T_{f}. Alternatively, the modified flight instructions may require that the predicted subsampled image frames overlap the current subsampled images (e.g., one-half or one-quarter of the current image is predicted to remain in the predicted image frame).

In a still further example, the modified flight instructions may limit movement of the UAV 100 in a manner that allows the UAV 100 to fly beyond positions or regions in which sufficient ones of the current features are identifiable but ensures that the UAV 100 can stop in time to temporarily rely on IMU data to return the UAV 100 to positions or regions in which sufficient ones of the current features are predicted to be identifiable (e.g., backtracking the flight path).

Upon completing operation 350, the operation 330 is repeated at subsequent times (e.g., corresponding to the time interval between capturing successive images in suboperation 312, the time interval for which predictions are made, or other suitable time).

Where certain elements of these implementations may be partially or fully implemented using known components, only those portions of such known components that are necessary for an understanding of the present disclosure have been described. Detailed descriptions of other portions of such known components have been omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein. Further, the present disclosure encompasses present and future known equivalents to the components referred to herein by way of illustration.

As used herein, the term “bus” is meant generally to denote all types of interconnection or communication architecture that may be used to communicate data between two or more entities. The “bus” could be optical, wireless, infrared or another type of communication medium. The exact topology of the bus could be for example standard “bus,” hierarchical bus, network-on-chip, address-event-representation (AER) connection, or other type of communication topology used for accessing, e.g., different memories in a system.

As used herein, the term “computing device” is meant to include personal computers (PCs) and minicomputers, whether desktop, laptop, or otherwise, mainframe computers, workstations, servers, personal digital assistants (PDAs), handheld computers, embedded computers, programmable logic device, personal communicators, tablet computers, portable navigation aids, J2ME equipped devices, cellular telephones, smart phones, personal integrated communication or entertainment devices, or literally any other device capable of executing a set of instructions.

As used herein, the term “computer program” or “software” is meant to include any sequence or human or machine cognizable steps which perform a function. Such program may be rendered in virtually any programming language or environment including, for example, C/C++, C#, Fortran, COBOL, MATLAB™, PASCAL, Python, assembly language, markup languages (e.g., HTML, SGML, XML, VoXML), as well as object-oriented environments such as the Common Object Request Broker Architecture (CORBA), Java™ (including J2ME, Java Beans), Binary Runtime Environment (e.g., BREW).

As used herein, the terms “connection,” “link,” “transmission channel,” “delay line,” and “wireless” mean a causal link between any two or more entities (whether physical or logical/virtual) which enables information exchange between the entities.

As used herein, the terms “integrated circuit,” “chip,” and “I_{C}” are meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM, PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the terms “processor,” “microprocessor,” and “digital processor” are meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary I_{C} die, or distributed across multiple components.

As used herein, the terms “network interface” and “communications interface” refer to any signal, data, and/or software interface with a component, network, and/or process. By way of non-limiting example, a communications interface may include one or more of FireWire (e.g., FW400, FW110, and/or other variation.), USB (e.g., USB2), Ethernet (e.g., 10/100, 10/100/1000 (Gigabit Ethernet), 10-Gig-E, and/or other Ethernet implementations), MoCA, Coaxsys (e.g., TVnet™), radio frequency tuner (e.g., in-band or OOB, cable modem, and/or other protocol), Wi-Fi (802.11), WiMAX (802.16), PAN (e.g., 802.15), cellular (e.g., 3G, LTE/LTE-A/TD-LTE, GSM, and/or other cellular technology), IrDA families, and/or other communications interfaces.

As used herein, the term “Wi-Fi” includes one or more of IEEE-Std. 802.11, variants of IEEE-Std. 802.11, standards related to IEEE-Std. 802.11 (e.g., 802.11 a/b/g/n/s/v), and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), HSDPA/HSUPA, TDMA, CDMA (e.g., IS-95A, WCDMA, and/or other wireless technology), FHSS, DSSS, GSM, PAN/802.15, WiMAX (802.16), 802.20, narrowband/FDMA, OFDM, PCS/DCS, LTE/LTE-A/TD-LTE, analog cellular, CDPD, satellite systems, millimeter wave or microwave systems, acoustic, infrared (i.e., IrDA), and/or other wireless interfaces.

As used herein, the terms “imaging device” and “camera” may be used to refer to any imaging device or sensor configured to capture, record, and/or convey still and/or video imagery which may be sensitive to visible parts of the electromagnetic spectrum, invisible parts of the electromagnetic spectrum (e.g., infrared, ultraviolet), and/or other energy (e.g., pressure waves).

While certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure.

While the above detailed description has shown, described, and pointed out novel features of the disclosure as applied to various implementations, it will be understood that various omissions, substitutions, and changes in the form and details of the devices or processes illustrated may be made by those skilled in the art without departing from the disclosure. The foregoing description is in no way meant to be limiting, but rather should be taken as illustrative of the general principles of the technologies.

What is claimed is:

1. A method of vision-based navigation of an aerial vehicle, comprising:
acquiring a first image at a first time with an imaging device of the aerial vehicle;
generating a first image pyramid of the first image, the first image pyramid comprising first pyramid layers that are copies of the first image at different resolutions;
identifying features in the first pyramid layers, and generating a first position and a first size for the respective features;
acquiring a second image at a second time that is after the first time with the imaging device, the second time being a current time;
generating a second image pyramid of the second image, the second image pyramid comprising second pyramid layers that are copies of the second image at the different resolutions;
identifying the features in the second pyramid layers, and generating a second position and a second size for the respective features;
determining current navigation information of the aerial vehicle according to changes from the first position to the second position of the respective features, the current navigation information including at least one of a current position, a current velocity, a current orientation, or a current orientation rate;
predicting a third position and a third size of the respective features in third pyramid layers of a third image pyramid corresponding to a third time, wherein the third position and the third size of the respective features in the third pyramid layers are determined according to a dynamic model of the aerial vehicle, the current navigation information, and user flight instructions, and the third time is a future time that is after the second time;
determining according to the third position and the third size of the respective features whether a sufficient number of the features will be identifiable in the third pyramid layers for determining future navigation information of the aerial vehicle; and
limiting flight of the aerial vehicle as compared to the user flight instructions upon predicting that an insufficient number of the features will be identifiable in the third image pyramid.

2. The method of claim 1, wherein in the operation of identifying features in the second pyramid layers includes identifying one of the features in one of the second pyramid layers having a first resolution, and the operation of predicting includes predicting that the one feature will be identifiable in one of the third pyramid layers having a second resolution that is different from the first resolution.

3. The method of claim 1, wherein in the operation of identifying features in the first pyramid layers includes identifying one of the features in one of the first pyramid layers having a first resolution, and the operation of identifying the features in the second pyramid layers includes identifying the one feature in one of the second pyramid layers having a second resolution that is different from the first resolution.

4. A method for navigating an aerial vehicle, comprising:
tracking visually distinct features from first subsampled images of a first image taken at a first time to second subsampled images of a second image taken at a second time after the first time;
determining navigation information for the second time based on the tracking; and
predicting whether sufficient ones of the visually distinct features will be identifiable at a third time to determine navigation information at the third time, the third time being a future time after the second time.

5. The method of claim 4, further comprising restricting flight of the aerial vehicle to a region in which sufficient ones of the visually distinct features are predicted to be identifiable at the third time.

6. The method of claim 5, wherein the operation of restricting flight limits a velocity of the aerial vehicle such that the aerial vehicle can stop before leaving the region.

7. The method of claim 5, further comprising receiving user flight instructions, and upon a determination that insufficient ones of the visually distinct features are predicted to be identifiable at the third time, generating modified flight instructions that are different from the user flight instructions, wherein the operation of restricting flight is performed according to the modified flight instructions.

8. The method of claim 7, wherein upon a determination that sufficient ones of the visually distinct features are predicted to be identifiable at the third time, flight is performed according to the user flight instructions.

9. The method of claim 4, wherein the operation of predicting includes predicting positions and sizes of the visually distinct features in third subsampled image frames of the third time.

10. The method of claim 9, wherein the operation of tracking visually distinct features includes identifying one or more features in one of the second subsampled images of a first resolution, and the operation of predicting includes predicting the one or more features to be identifiable in one of the third subsampled image frames of a second resolution that is different from the first resolution.

11. The method of claim 4, wherein the operation of tracking the visually distinct features includes identifying the visually distinct features in the first subsampled images, and identifying in the second subsampled image those of the visually distinct features that were identified in the first subsampled images.

12. The method of claim 11, wherein the operation of determining navigation information includes deriving changes in position and orientation of the aerial vehicle from changes in positions of the visually distinct features between the first subsampled images and the second subsampled images.

13. The method of claim 4, wherein the first subsampled images are copies of the first image at different resolutions, and the second subsampled images are copies of the second image at the different resolutions.

14. The method of claim 4, wherein the navigation information includes at least one of a position, a velocity, an orientation, an orientation rate, or a component thereof of the aerial vehicle.

15. A method of vision-based navigation of an aerial vehicle, comprising:
predicting whether sufficient current features identified in current subsampled images of a current image will be identifiable in future subsampled image frames for determining future navigation information, wherein the operation of predicting is performed according to a dynamic model, current navigation information, and user flight instructions, and wherein the future subsampled images correspond to a future time; and
upon a determination that an insufficient number of the current features will be identifiable in the future subsampled image frames, generating modified flight instructions that are different from the user flight instructions.

16. The method of claim 15, wherein the operation of predicting includes predicting one of the current features to be identifiable in one of the future subsampled image frames having a resolution that is different from another resolution of one of the current subsampled images in which the one current feature is identified.

17. The method of claim 15, wherein the operation of predicting includes predicting future positions and future sizes of the current features in the future subsampled image frames.

18. The method of claim 17, wherein the future sizes of the current features are used to determine which of the future subsampled image frames each of the current features will be identifiable in the future subsampled image frames.

19. The method of claim 15, further comprising determining current navigation information from changes in positions of the current features between previous subsampled images of a previous image and the current subsampled images, the previous image being captured prior to the current image.

20. The method of claim 19, wherein one of the current features is identified in one of the previous subsampled images having a resolution that is different from another resolution of one of the current subsampled images in which the one current feature is identified.
